(19) United States
(12) Patent Application Publication
(10) Pub. No.: US 2018/0085665 A1
(43) Pub. Date: Mar. 29, 2018

(54) FANz Play, a dynamic interactive mobile sports and entertainment application that will allow the fans to compete against each other live using their smart phones/devices, sports or event timed specific trivia and the jumbo trons that are integrated with the application.

(71) Applicant: Henrietta Walls, Woodstock, MD (US)

(72) Inventor: Henrietta Walls, Woodstock, MD (US)

(21) Appl. No.: 15/613,136

(22) Filed: Jun. 3, 2017

Related U.S. Application Data
(60) Provisional application No. 62/345,718, filed on Jun. 3, 2016.

(51) Int. Cl. A63F 13/27; A63F 13/80; A63F 13/795; A63F 13/61; A63F 13/92; A63F 13/327; A63F 13/332; A63F 13/32; A63F 13/46

(52) U.S. Cl. CPC A63F 13/27; A63F 13/80; A63F 13/795; A63F 13/61; A63F 2300/8064; A63F 13/327; A63F 13/332; A63F 13/32; A63F 13/46; A63F 13/92

(57) ABSTRACT

In some embodiments, the disclosure provides a system for controlling displays at a location during an event. In some embodiments, the system includes an electronic device associated with a first user, a public display associated with the location, and a controller. In some embodiments, the controller is configured to receive an indication that the first user is present at the location, detect a user affiliation associated with the first user, and generate a user profile based, at least in part, on the user affiliation. In some embodiments, the controller is configured to transmit targeted and public display controls, detect a user response at the electronic device, and generate targeted and public award profiles based, at least in part, on the user response. In some embodiments, the controller is further configured to transmit the targeted and public award profiles, which may include targeted and public display controls.

### BACKGROUND

The present disclosure relates to controlling displays during an event. More particularly, the disclosure related to controlling a plurality of displays during an event at an event location and various remote locations.

### SUMMARY

In some embodiments, the disclosure provides a method of controlling a plurality of displays at a location during an event, including receiving an indication that first user is present at the location, detecting a user affiliation associated with the first user, and generating a user profile based, at least in part, on the user affiliation. In some embodiments, the method further includes transmitting a targeted display control to a personal electronic device, transmitting public display control to a public display associated with the location, and detecting a user response. In some embodiments, the personal electronic device is associated with the first user. In some embodiments, the transmitting the targeted display control is based, at least in part, on the user profile. In some embodiments, the transmitting the public display control is based, at least in part, on the event. In some embodiments, the user response is detected at the personal electronic device. In some embodiments, the method further includes generating a targeted award profile, generating a public award profile, transmitting the targeted award profile to the personal electronic device, and transmitting the public award profile to the public display. In some embodiments, the generating the targeted award profile is based, at least in part, on the user response and the user profile. In some embodiments, the generating the public award profile is based, at least in part, on one or more of the location and the event. In some embodiments, the targeted award profile includes a second targeted display control. In some embodiments, the public award profile includes a second public display control.

In some embodiments, the disclosure provides a system for controlling displays at a location during an event, including a personal electronic device associated with a first user, a public display associated with the location, and a controller. In some embodiments, the controller includes a non-transitory computer-readable medium storing program instructions executable by one or more processors to receive an indication that the first user is present at the location, detect a user affiliation associated with the first user, and generate a user profile based, at least in part, on the user affiliation. In some embodiments, the program instructions are further executable to transmit a targeted display control, transmit a public display control, and detect a user response. In some embodiments, the targeted display control is transmitted to the personal electronic device. In some embodiments, the public display control is transmitted to the public display based, at least in part, on the event. In some embodiments, the user response is detected at the personal electronic device. In some embodiments, the program instructions are further executable to generate a targeted award profile, generate public award profile, transmit the targeted award profile to the personal electronic device, and transmit the public award profile to the public display. In some embodiments, the targeted award profile is generated based, at least in part, on one or more of the user profile and the user response. In some embodiments the public award profile is generated based, at least in part on one or more of the event and the user response. In some embodiments, the targeted award profile includes a second targeted display control. In some embodiments, the public award profile includes a second public display control.

In some embodiments, the disclosure provides a system for controlling displays during an event, including an event display associated with an event location, a remote display associated with a remote location apart from the event location, and a controller. In some embodiments, the controller includes a non-transitory computer-readable medium storing program instructions executable by one or more processors to receive an indication that at least one local user is present at the event location, receive an indication that at least one remote user is present at the remote location, detect “user affiliations” associated with the at least one local user and the at least one remote user, and generate respective user profiles of the at least one local user and the at least one remote user based, at least in part, on the “user affiliations.” In some embodiments, the program instructions are further executable to generate a user engagement prompt including a targeted display control and a public display control. In some embodiments, the program instructions are further executable to transmit the public display control to the event display and the remote display. In some embodiments the program instructions are further executable to transmit the targeted display control to at least one electronic device associated with the at least one local user and at least one electronic device associated with the at least one remote user based, at least in part on the “user affiliation” and user location of the local user and the remote user.

In some embodiments, the program instructions are further executable to detect respective user responses to the user engagement prompt, the respective user responses associated with the at least one local user and the at least one remote user. In some embodiments, the program instructions are further executable to generate a public award profile, generate a victory award profile, and generate a participation award profile. In some embodiments, the public award profile is generated based, at least in part, on the event. In some embodiments, the victory award profile is generated based, at least in part, on the respective user responses. In some embodiments, the participation award profile is generated based, at least in part, on the respective user responses. In some embodiments, the public award profile includes a second public display control, and the program instructions are further executable to transmit the public award profile to the event display and the remote display. In some embodiments, the victory award profile includes a second targeted display control, and the program instructions are further executable to transmit the victory award profile to electronic devices associated with a plurality of users selected from the at least one local user and the at least one remote user. In some embodiments, the participation award profile includes a third targeted display control, and the program instructions are further executable to transmit the participation award profile to electronic devices associated with a plurality of user s selected from the at least one local user and the at least one remote user.

In some embodiments, the program instructions are further executable to generate a remote user engagement prompt, including a remote public display control and a remote targeted display control. In some embodiments, the program instructions are further executable to transmit the remote public display control to the remote display and transmit the remote targeted display control to the at least one electronic device associated with the at least one remote user. In some embodiments, the program instructions are further executable to generate a remote public award profile, generate a remote victory award profile, and generate a remote participation award profile. In some embodiments, the remote public award profile is generated based, at least in part, on the event and the remote location. In some embodiments, the remote victory award profile is generated based, at least in part, on the user responses associated with the at least one remote user. In some embodiments, the remote participation award profile is generated based, at least in part, on the user responses associated with the at least one remote user. In some embodiments, the remote public award profile includes a second remote public display control, and the program instructions are further executable to transmit the remote public award profile to the remote display. In some embodiments, the remote victory award profile includes a second remote targeted display control, and the program instructions are further executable to transmit the remote victory award profile to at least one electronic device associated with a plurality of users selected from the at least one remote user. In some embodiments, the remote participation award profile includes a third remote targeted display control, and the program instructions are further executable to transmit the remote participation award profile to at least one electronic device associate with a plurality of users selected from the at least one remote user.

Other aspects of the disclosure will become apparent by consideration of the detailed description and accompanying drawings.

### BRIEF DESCRIPTION OF THE DRAWINGS

FIG. 1 illustrates a system for controlling displays, according to some embodiments.

FIG. 2 is a block diagram of an electronic device, according to some embodiments.

FIG. 3 is a block diagram of a controller, according to some embodiments.

FIG. 4 illustrates a display of an electronic device, according to some embodiments.

FIG. 5 illustrates a display of an electronic device, according to some embodiments.

FIG. 6 illustrates a display of an electronic device, according to some embodiments.

FIG. 7 illustrates a display of an electronic device, according to some embodiments.

FIG. 8 illustrates a display control, according to some embodiments.

FIG. 9 illustrates a display of an electronic device, according to some embodiments.

FIG. 10 is a flow diagram of a method of controlling a plurality of displays, according to some embodiments.

FIG. 11 is a flow diagram of a method of controlling a plurality of displays, according to some embodiments.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

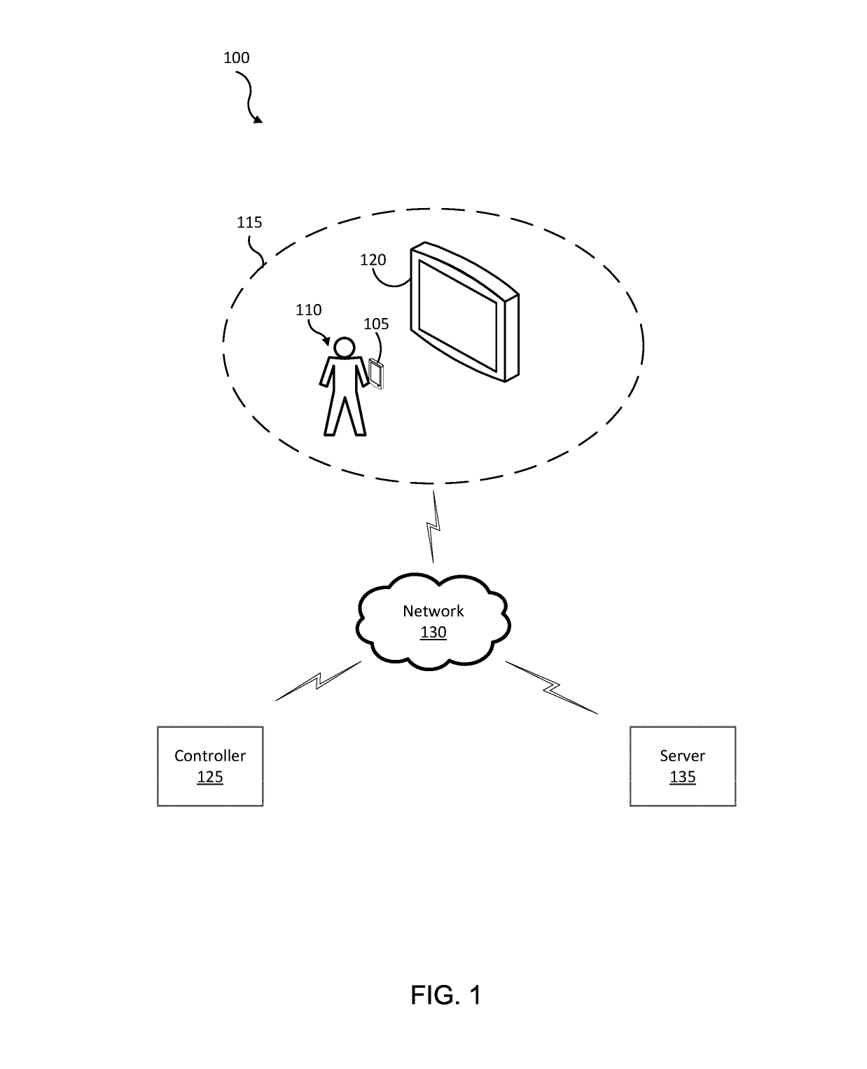

FIG. 1 illustrates a system 100 for controlling displays during an event, the system 100 including an electronic device 105 associated with a user 110 at a location 115 during the event, a public display 120 associated with the location 115, a controller 125 operably coupled to the electronic device 105 and the public display 120 over a network 130. In some embodiments, the system 100 may further include one or more servers 135 communicable with one or more of the electronic device 105, the controller 125, and the public display 120 over the network 130. The electronic device 105 may include smartphones, tablets, smart watches, laptops, netbooks, portable gaming devices, or any suitable personal electronic device. The public display 120 may be any display associated with the location 115, for example, a jumbotron, ribbon display, or conventional electronic displays, such as television displays or computer monitors. Further, the public display 120 may include non-emissive displays, such as LCD screens or e-ink displays, volumetric or holographic displays. The controller 125 may be embodied in a computer system associated with the location 115 or may, alternatively or in addition, be embodied in the server 135 and operably coupled to the electronic device 105 and the public display 120 over the network 130. The network 130 may include any wired networks, such as LAN or Ethernet, wireless networks, such as Wi-Fi or cellular data services, or combinations thereof. For example, the electronic device 105 may connect to a cellular data network while the controller 125 couples to the public display 120 over a LAN.

Accordingly, an indication may be received by the controller 125 that the guest or user 110 is present at the location 115, for example, over the network 130. Further, the controller 125 may transmit and receive other data to the electronic device 105 and the public display 120 over the network 130. For example, the controller 125 may transmit a user engagement prompt to the electronic device 105. Additionally, the controller 125 may receive a user response to the engagement prompt from the electronic device 105. Accordingly, display controls related to the event may be transmitted to one or more electronic devices 105 and one or more public displays 120. For example, a targeted display control may be transmitted to the electronic device 105 and a public display control may be transmitted to the public display 120. Further, the targeted display control and the public display control may be adapted or modified based on, for example, the presence of a specific user or a user response, user engagement during the event may be improved. Further, these display controls may be generated or adapted iteratively based, for example, on a plurality of user responses received, for example, while conducting an interactive game. Accordingly, user experiences during the event may be improved as well as generation and adaptation of targeted and public display controls, such as award profiles or advertisements.

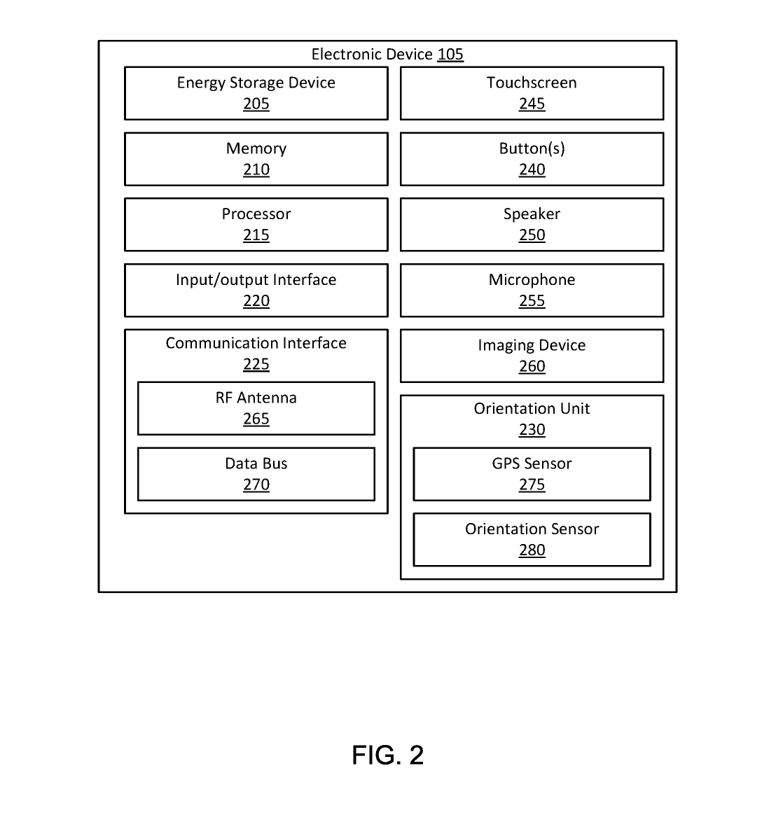

FIG. 2 illustrates the electronic device 105, according to some embodiments. The electronic device 105 includes an energy storage device 205, a memory 210, a processor 215, an input/output (I/O) interface 220, a communication interface 225, and an orientation unit 230. In the illustrated embodiment, the I/O interface includes a touchscreen 245, buttons 240, a speaker 250, a microphone 255, and an imaging device 260. The energy storage device 205, such as a battery, is configured to supply electrical energy to various components of the electronic device 105, such as the memory 210, the processor 215, the I/O interface 220, the communication interface 225, and the orientation unit 230. The memory 210 include any non-transitory computer-readable medium. For example, the memory 210 may be configured as solid state storage. In some embodiments, the memory 210 stores program instructions executable by the processor 215 to implement various firmware and software. For example, the memory 210 may include program instructions executable by the processor 215 to implement an Operating System (OS), such as iOS, Windows, or Android, or to implement one or more mobile applications.

The I/O interface 220 is configured for user interaction with the electronic device 105 through a plurality of inputs and outputs. For example, a user engagement prompt may be displayed on the touchscreen 245, and the user 110 may then interact with the user engagement prompt. For example, the user 110 may select a response via a gesture on the touchscreen 245 or by issuing a voice command to the microphone 255. In some embodiments, a user engagement prompt may include one or more alerts or notifications, such as an auditory, visual, or haptic feedback alert, which may be transmitted to the user via the I/O interface 220. For example, the I/O interface 220 may be configured to produce an auditory alert with the speaker 250 substantially at the same time as displaying the user engagement prompt on the touchscreen 245. Additionally, the user 110 may capture various images related to the location, the event, or themselves with the imaging device 260, for example, a camera.

The communication interface 225 enables the electronic device 105 to connect to one or more networks and devices. For example, in the illustrated embodiments, the communication interface 225 includes an RF antenna 265, and a data bus 270, for example a USB-C connector. Accordingly, the electronic device 105 may be operably coupled to the controller 125 to transmit and receive data during the event, for example, to receive a user engagement prompt and to transmit a user response. The orientation unit 230 detects a geographic location of the electronic device 105, for example, with a GPS sensor, as well as an orientation of the electronic device 105 with one or more orientation sensors 280, such as accelerometers and magnetometers.

Accordingly, an indication the user 110 is present at the location 115 may be transmitted from the electronic device 105, for example, in response to the GPS sensor 275 detecting that the electronic device 105 is within a geofence associated with the location 115. Alternatively, or additionally, the electronic device 105 may transmit the indication in response to a user input, for example, a gesture on the touchscreen 245 or voice confirmation received with the microphone 255. Further, the communication interface 225 enables the electronic device 105 to communicate with any number of electronic devices directly or via the network 130, such as the public display 120, the controller 125, and the server 135. For example, the electronic device 105 may transmit an indication that the user 110 is present at the location 115 to the controller 125 via the network 130. Similarly, the electronic device 105 may receive display controls, for example a targeted display control embodied in a user engagement prompt or an award profile, over the network 130. These display controls may be presented on the touchscreen 245 to the user 110 alongside, for example, a set of pre-defined user responses. Accordingly, the user 110 may select one or more of the user responses, and the one or more selected user responses may be transmitted via the network 130.

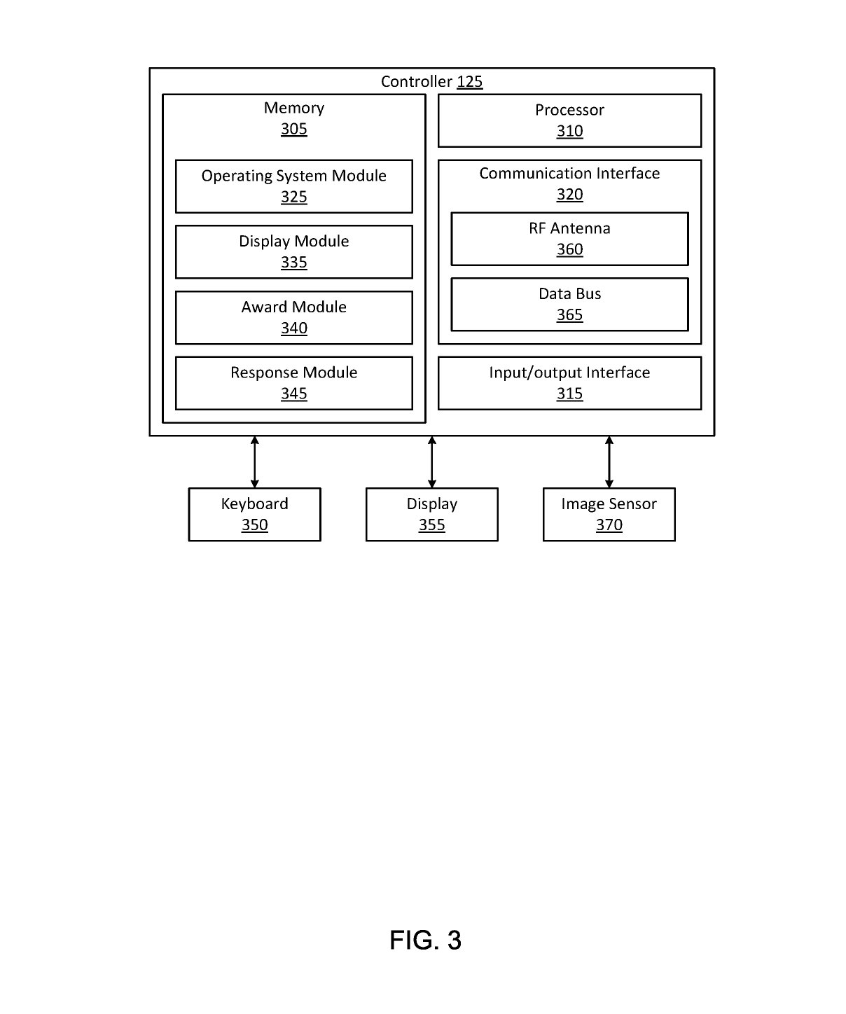

FIG. 3 is a diagram of a controller 125, according to some embodiments. The controller 125 includes a memory 305, a processor 310, an I/O interface 315, and a communication interface 320. The memory 305 includes any non-transitory computer-readable medium. For example, the memory 305 may be configured as solid state storage. In some embodiments, the memory 305 stores program instructions executable by the processor 310 to implement various firmware and software. For example, the memory 305 may include program instructions executable by the processor 310 to implement an Operating System (OS), such as iOS, Windows, or Android, or to implement one or more mobile applications. In the illustrated embodiment, the memory 305 includes an OS module 325, a user profile module 330, a display module 335, an award module 340, and a response module 345. The I/O interface 315 is configured to enable interaction with the controller, for example, via one or more keyboards 350 or computer displays 355. In the illustrated embodiment, the communication interface 320 includes an RF antenna 360 and a data bus 365, such as an Ethernet connection.

The user profile module 330 is configured for generating and storing user profiles associated with respective users. A user profile can include various data related to a user, such as a user's age or user affiliation, and may be received from an electronic device associated with the user. In other embodiments, the user profile data may be queried and fulfilled by the server 135. In other embodiments, user profile data may be detected by one or more sensors associated with the location 115. For example, an image sensor 370 at a sports arena 115 during a game or match may capture user profile data that a user is affiliated or supports one of the teams competing in the game, for example, if the user is wearing a team jersey.

The display module 335 is configured to generate display controls for respective displays at the location 115 during an event. The display module 335 may generate, modify, or adapt respective display control to accommodate different display capabilities of the respective displays. For example, adjusting color balance, resolution, or enlarging text within a user engagement prompt. In other embodiments, the display module 335 may transmit substantially similar display controls to respective displays, which the displays may adapt or modify based on their respective display capabilities. Further, the display module 335 is configured to generate a plurality of display controls for respective display devices simultaneously. Accordingly, targeted display controls may be transmitted to a plurality of electronic devices and public display controls may be sent to a plurality of public displays and, in some embodiments, the targeted display controls and the public display controls are substantially similar display controls. For example, in the case that human-readable text is included in the display control, for example, a display control embodied in a user engagement prompt, the display module 335 may adapt the display control to generate a targeted display control and a public display control both of which include the human-readable text. Thus, readability of the text on respective displays may be improved.

The award module 340 is configured to generate award profiles for users 110 at one or more locations during an event, such as location 115. The award module 340 may be configured to generate an award profile, for example, a discount code or coupon, based at least in part on one or more user profiles. For example, the award module 340 may not generate award profiles related to alcohol sales at the location 115 if user profiles indicate that the user demographics are primarily underage. Further, the award module 340 may adapt award profiles, for example, based on one or more user responses or redemptions of the award profiles. For example, an award profile redeemable for t-shirts at the location 115 may be selectively generated based on an inventory of the t-shirts. Accordingly, the award module 340 may be configured to increase user engagement and enjoyment at the location 115 during the event.

The response module 345 is configured to generate a user engagement prompt as well as evaluate received user responses. For example, the response module 345 may generate a user engagement prompt including a trivia question. In some embodiments, the response module 345 may generate one or more pre-defined user responses associated with the user engagement prompt. For example, a list of players on a sports team. Further, the response module 345 is configured to evaluate the user responses. For example, to determine if a user response is “correct” or acceptable or within one or more rules of a game. Further, the response module 345 may be configured to interface with the award module 340. For example, the response module 345 and award module 340 may iteratively generate user engagement prompts and associated user responses, receive responses from a plurality of users 110, and generate one or more award profiles based, at least in part, on the user responses. Accordingly, an interactive game, including one or more rounds, may be conduct amongst a plurality of users 110. Further, these interactive games may be adapted based on, for example, the location 115, the event, or the users 110. For example, the user engagement prompts of the interactive game may be adapted as a multiple choice, true/false, identify, fill-in-the-blank, contextual trivia, and the like. Further, the user engagement prompts of the interactive game may be adapted based on the user profiles of the users 110, for example, to implement inter-generational interactive games (e.g. Millennials vs. Baby-Boomers), gender-based interactive games, attendance/participation-based games (e.g. devoted fans vs. casual fans), or interactive games based on any suitable aspect of the users 110.

The communication interface 320 enables the controller 125 to connect to one or more networks and devices. For example, in the illustrated embodiment, the communication interface 320 includes the RF antenna 360 and the data bus 365. Accordingly, the controller 125 may wirelessly connect to one or more networks or devices, for example the image sensor 370, over Wi-Fi or Bluetooth connection. Further, the controller 125 may connect to a device over a wired connection at the data bus, for example, an Ethernet connection.

In the illustrated embodiment, the user profile module 330, the display module 335, and the award module 340 are described as being stored in the memory 305 of the controller 125. However, one or more of these modules may be stored remotely in another non-transitory memory, such as on the server 135. Accordingly, the processor 310 of the controller 125 may be able to execute program instructions received from a remote memory via the network 130. The controller 125 may receive an indication that the user 110 is present at the location 115 and generate a user engagement prompt, for example, including a targeted display control, with one or more of the user response module 345, the award module 340, and the display module 335.

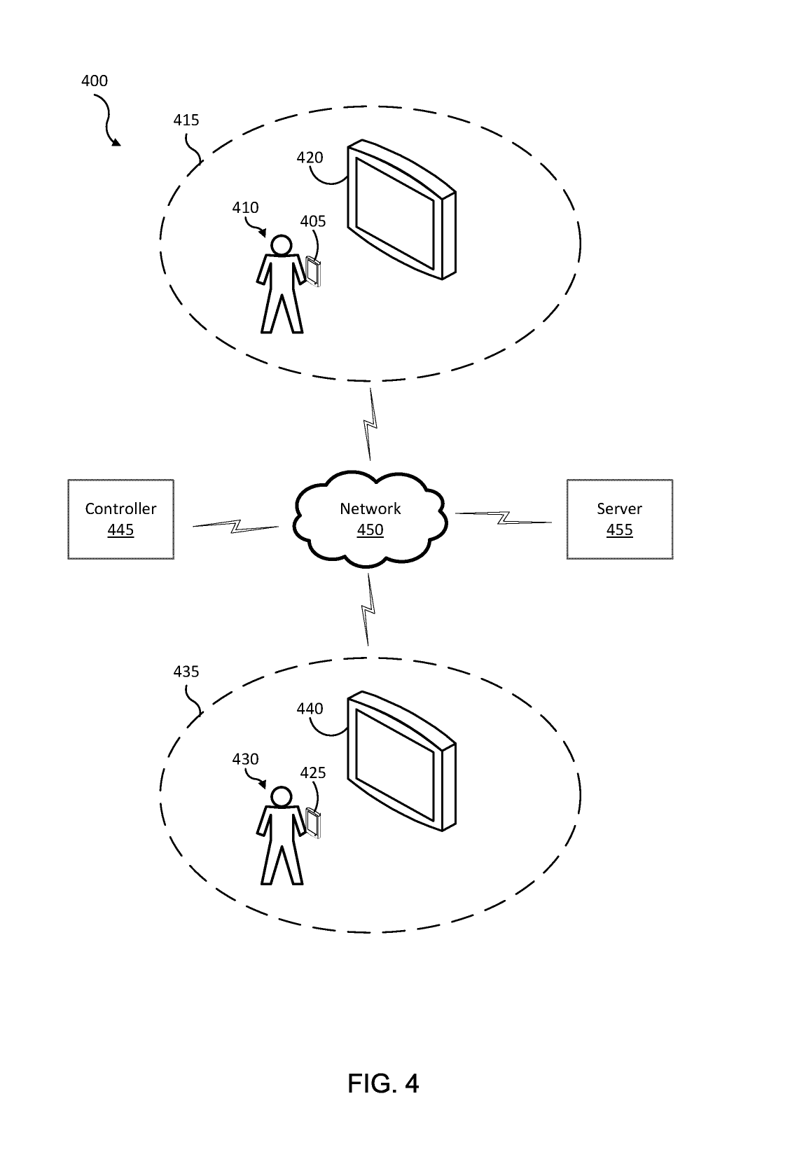

FIG. 4 illustrates a system 400 for controlling displays during an event, according to some embodiments. The system 400 includes an electronic device 405 associated with a local user 410 at an event location 415, such as a sports arena, concert venue, movie theater, and the like. The system 400 further includes an event display 420 associated with the event location 415, an electronic device 425 associated with a remote user 430 located at a remote location 435 apart from the event location 415, and a remote display 440 associated with the remote location 435. The system further includes a controller 445. In some embodiments, the system 400 may further include a network 450 and one or more servers 455. The controller 445 is operably coupled to the electronic devices 405, 425 and the displays 420, 440, for example, over the network 450.

Additionally, the controller 445 may connect to the one or more servers 455 over the network 450. The electronic devices 405, 425 may include smartphones, tablets, smart watches, laptops, netbooks, portable gaming devices, or any suitable personal electronic device. The event display 420 may be any display associated with the event location, for example, a jumbotron, ribbon display, or conventional electronic display. The remote display 440 may include any display associated with the remote location 435, for example, a television display, computer monitor, or projection display. The remote location 435 may include any public or private location, such as a restaurant, bar, church, school, or home. In some embodiments, the system 400 may include more than one remote location 435, such as a plurality of homes in a neighborhood, geographically distinct remote locations 435, such as a chain of sports bars, or any combination thereof. Accordingly, each user experience may be tailored with increasing granularity, for example, based on user profiles at respective event locations 415 and remote locations 435.

The controller 445 may be configured substantially similarly to controller 125 and, in some embodiments, may be embodied in a computer system associated with the event location 415 or the remote location 435 or, in other embodiments, be embodied in the server 455 and operably coupled to the electronic devices 405, 425 and the displays 420, 440 over the network 450. The network 450 may include any wired networks, such as LAN or Ethernet, wireless networks, such as Wi-Fi or cellular data services, or any combination thereof.

Accordingly, an indication may be received by the controller 445 that at least one local user 410 is present at the event location 415, for example, via the network 450. Additionally, an indication may be received by the controller 445 that at least one remote user 430 is present at the remote location 435. The controller 445 may then generate one or more user engagement prompts, such as a trivia question, which include one or more display controls. The display controls, such as a targeted display control and a public display control, may be transmitted from the controller 445 to the electronic devices 405, 425 and the displays 420, 440 via the network 450. Similarly, user responses, such as user responses associated with the user engagement prompt, may be received by the controller 445 over the network 450. Display controls related to the event location 415, the remote location 435, and the event may be transmitted to respective displays, such as one or more electronic devices 405, 425, one or more event displays 420, and one or more remote displays 440.

Further, as the targeted display controls and the public display controls may be generated or adapted based on, for example, the user responses of one or more of the local user 410 and the remote user 430, user engagement during an event may be improved. Additional, as display controls may be generated or modified individually, event display controls and remote display controls may be transmitted to displays at the event location 415 and displays at the remote location 435, respectively. For example, a targeted display control may be transmitted to electronics devices 405 associated with one or more local users 410 while a remote targeted display control may be transmitted to electronic devices 425 associated with one or more remote users 430 at the remote location 435.

As these displays may be generated or adapted based on user responses received, generation and adaptation of targeted and public display controls, such as included in award profiles or advertisements, may be improves. For example, award profiles may be generated adapted to include discounts or endorsements based on, for example, a geographic region of the event location 415 or the remote location 435.

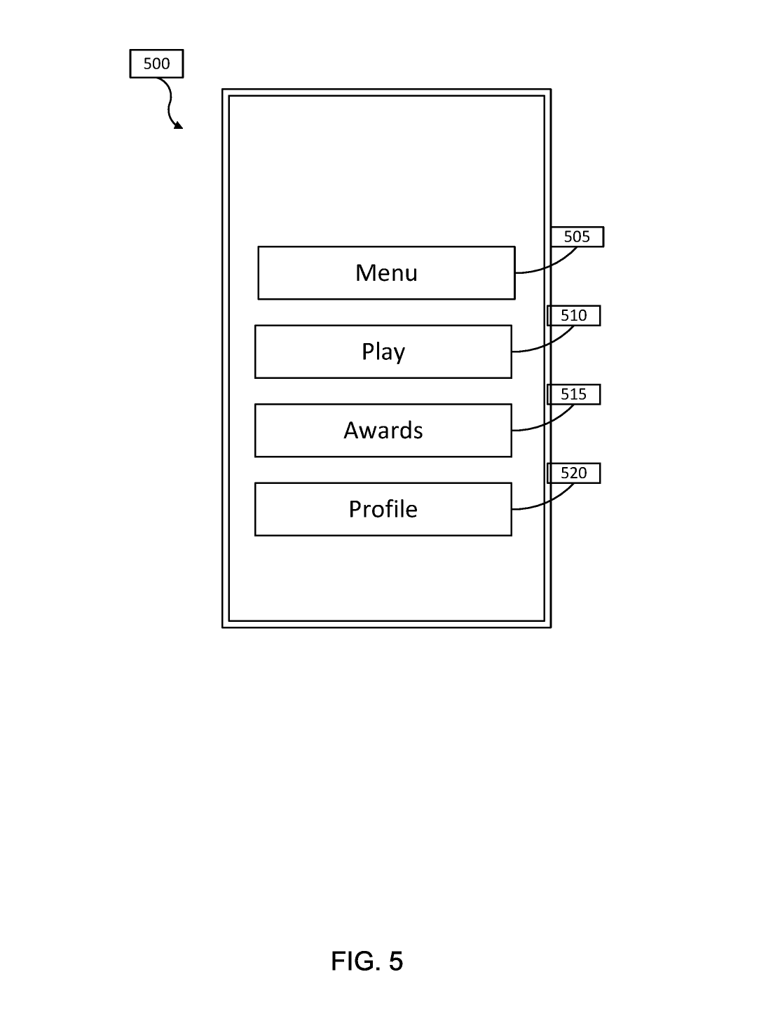

FIG. 5 illustrates an example display 500 on a touchscreen of a personal electronic device, according to some embodiments. In the illustrated embodiment, the display includes a plurality of user selectable regions or icons which enable a user to interact with an application executing on the personal electronic device. In the illustrated embodiment, a menu icon 505, a play icon 510, an award icon 515, and a user profile icon 520 are displayed. Accordingly, the user may select one or more of these icons to navigate the app or engage in aspects of an event via the personal electronic device. For example, the user may select the award icon 515 to view or redeem previously received award profiles. The user may select the play icon 510 to indicate that they wish to play or otherwise engage in an event, either at the event location or at a remote location. For example, the user may select the play icon 510 to indicate that they wish to participate in a user poll, questionnaire, or distributed interactive game via the app. Further, the user may select the user profile icon 520 in order to select one or more user affiliations. For example, the user may wish to supply one or more default user affiliations, such as their favorite teams of respective sports or leagues, or conditional user affiliations, such as a preferential selection between competitors. Further, in some embodiments, the user profile may provide feedback to the user, such as a number or location of events attended, or different metrics of objective or comparative user engagement. For example, the user profile feedback may inform the user that they have attended more events than half of the other users in attendance at an event or, by way of additional example, that the user has correctly answered 80% of the user engagement prompts.

In other embodiments, the display 500 may include more or fewer icons. For example, the display 500 may include an icon selectable to open a marketplace via the app. For example, a user may select a ticket icon to purchase tickets to the event. In other embodiments, the display screen may include a store icon which a user may select to purchase merchandise associated with the location, event, and the like.

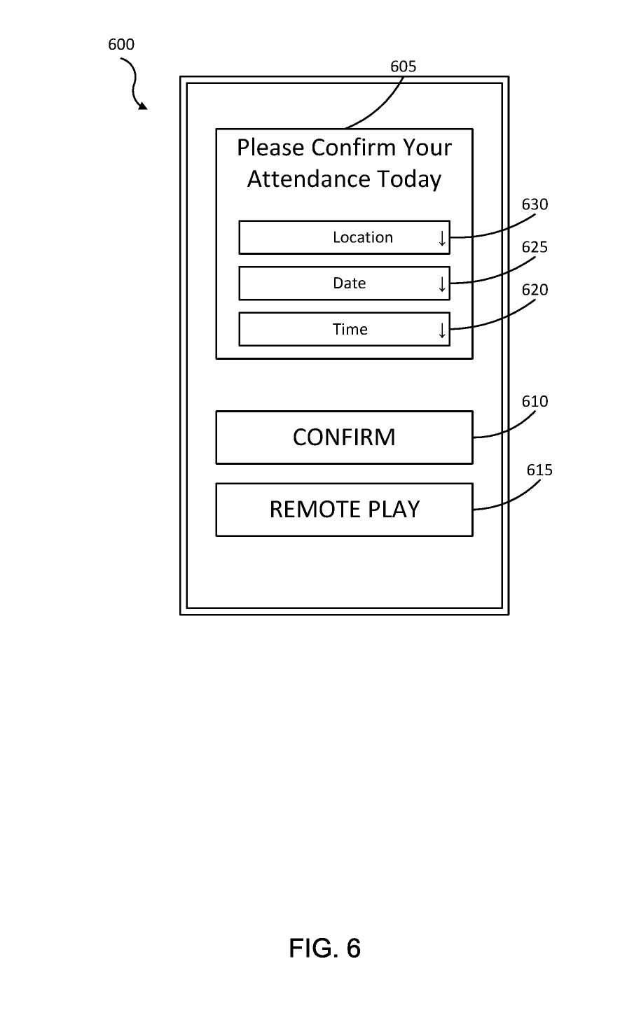

FIG. 6 illustrates a display 600 of an application executing on a personal electronic device. The display 600 includes an event confirmation prompt 605, a confirmation icon 610, a remote play icon 615, and time 620, date 625, and location 630 information associated with the event. In some embodiments, the display screen presents one or more user affiliations for the event, such as a pair of team logos. In other embodiments, the display screen may include more or fewer elements, such as a plurality of icons for a user to select or input a location, a date, a time, a user affiliation, for a current or future event. In some embodiments, the display screen may include an option for the user to purchase tickets to the present event.

In the illustrated embodiment, the event confirmation prompt 605 is presented to a user responsive to a detection via a GPS sensor of the electronic device that the user is present at the event. In other embodiments, a user may select or confirm an event by inputting the requisite information, in whole or in part. For example, the user may input a sport and are subsequently presented with a list of associated events associated with that sport that are occurring. In some embodiments, the information 620, 625, 630 associated with the event is automatically retrieved, for example, from a server. In other embodiments, the user may select or confirm a match by capturing a remote display control indicative of the event, such as capturing an image of a QR code associated with the event with an image sensor of the electronic device. In some embodiments, the event confirmation may include a user affiliation confirmation. For example, in the case that one of the available user affiliations corresponds to a default user affiliation. In some embodiments, the user may further be presented with the option to input their section, row, and seat number. Accordingly, in some embodiments, award profiles may be based on, for example, user responses from different sections or remote locations. For example, the user may be a remote user at a remote location, such as their house or a sports bar. Accordingly, the user may select the “remote play” icon.

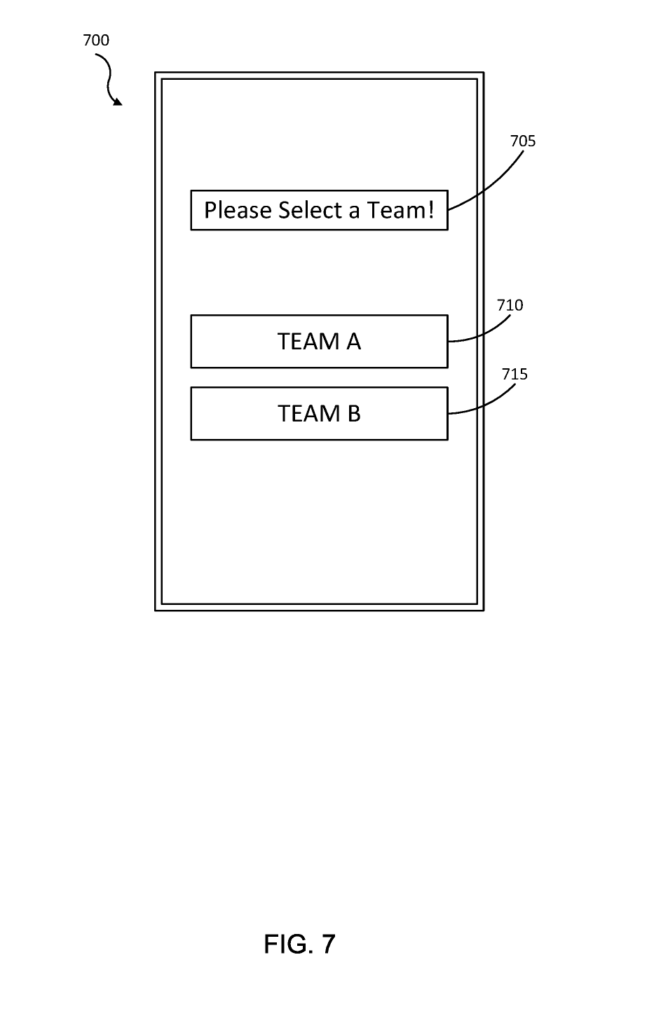

FIG. 7 illustrates an example display 700 of an application executing on an electronic device. The display 700 presents a user affiliation prompt 705, a first user affiliation icon 710, and a second user affiliation icon 715. Subsequent to confirming that the user wishes to participate in the event, either at the event location or at a remote location, the user affiliation prompt is presented to the user. Accordingly, the user may indicate their affiliation at the event. In the illustrated embodiment, the first user affiliation selection and the second user affiliation selection are a pair of sports teams competing in the event. In other embodiments, the user affiliation prompt may include more or fewer than two user affiliations. In some embodiments, a user may be able to select a plurality of user affiliations. For example, at a music festival or a sports tournament.

In the illustrated embodiment, the user affiliation prompt is presented to the user but, in other embodiments, the user affiliation may be detected automatically. Accordingly, a user affiliation confirmation prompt may be presented instead. For example, the user profile may include a default user affiliation, such as stored in a server, or the user affiliation may be detected for example with one or more sensors associated with the event location. In the illustrated embodiment, the user affiliation prompt is described as following the user event confirmation prompt, but this is not required. In other embodiments, the user may select a user affiliation and, subsequent to indicating the user affiliation, the application may present a list of events in which the affiliated group, team, or band are participating. As most sports teams and bands only participate in one event at a time, the user affiliation response may be indicative that a user wishes to participate in a particular event, either at the event location or at a remote location.

Thus far, a user affiliation has been primarily described as relating to a band or sports team, but more or less granularity may be afforded. For example, a user may select a user affiliation with one or more players or band members participating in an event. Accordingly, more diverse award profiles may be generated, for example, on a plurality of user affiliations associated with one or more users. Further, user engagement prompts may be generated based on a plurality of user affiliations. Accordingly, targeted display controls may be transmitted to users most likely to respond, which may improve user engagement at the event.

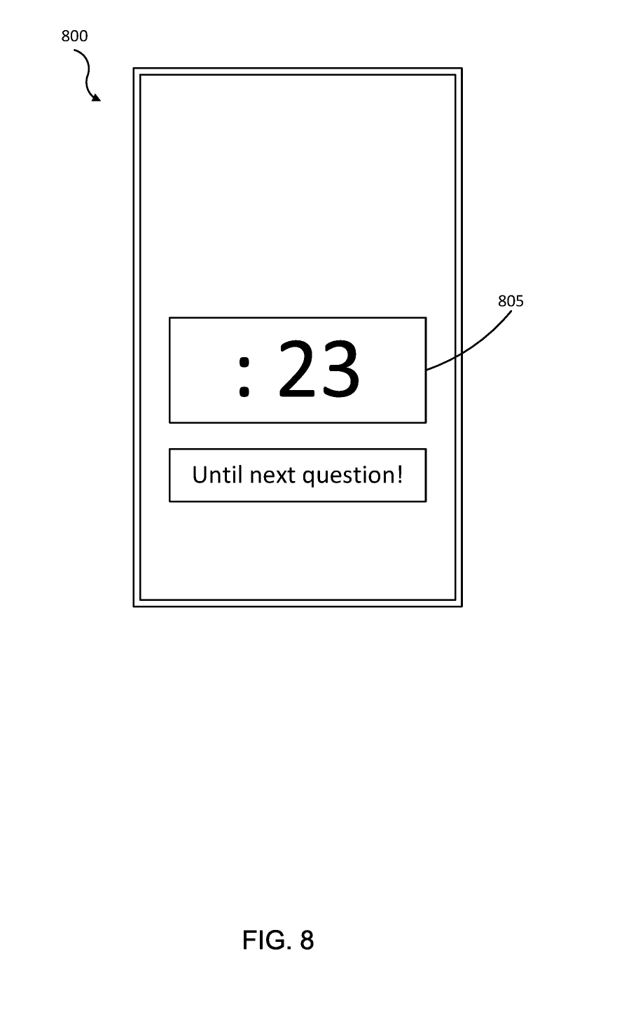

FIG. 8 illustrates a display 800 of an application executing on an electronic device. The display 800 includes a notification counter 805. In the illustrated embodiment, the notification counter 805 is a countdown timer which displays the remaining seconds until a first targeted display control will be transmitted to the electronic device. Further, the notification counter 805 may be accompanied with one or more additional alerts or notifications, such as an audible alert or vibratory feedback of the electronic device. In other embodiments, the display screen may include a plurality of notification counters 805. For example, the display screen may include a notification counter 805 which displays the remaining seconds until a first public display control will be transmitted. By way of additional example, the notification counter 805 may be based on any suitable quantity, such as a remaining number of points, or measured decibel level. For example, a display control may only be transmitted once the crowd cheers loudly enough. Accordingly, one or more of a user engagement prompt or display control may have one or more bases, which may improve user engagement at an event.

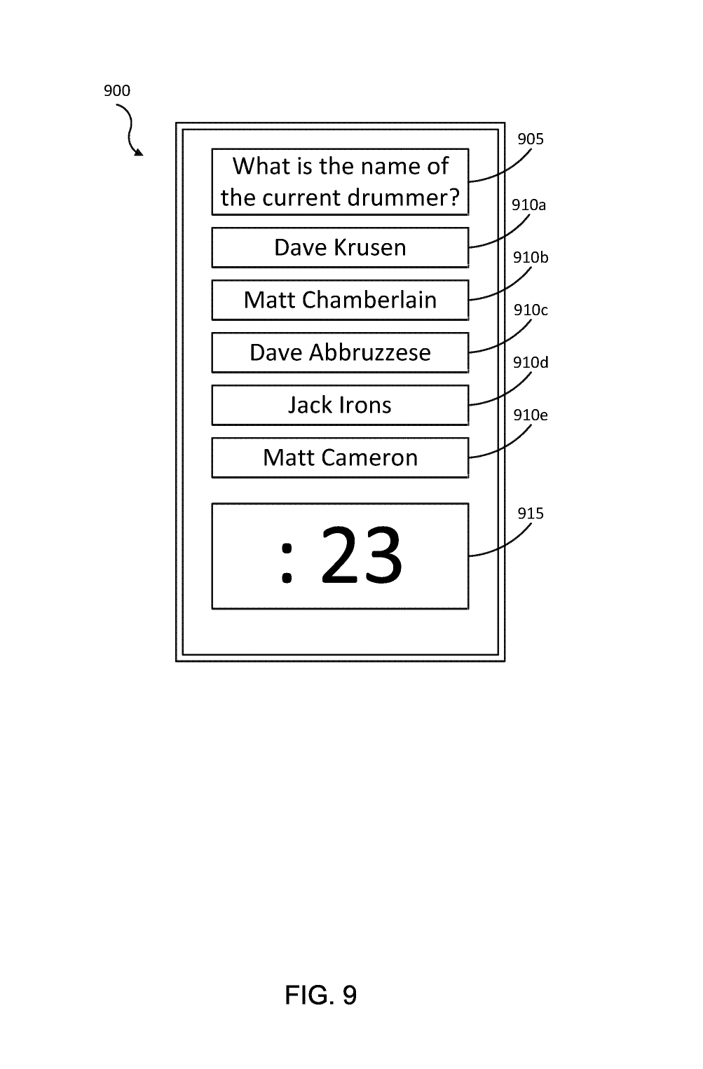

FIG. 9 illustrates a display 900 of an application executing on an electronic device. The display 900 includes a first user engagement prompt 905, five pre-defined user responses 910 associated with the first user engagement prompt 905, and a response interval counter 915. In this embodiment, the first user engagement prompt 905 includes a trivia question, of which one of the user responses 910 is a “correct” answer. In other embodiments, the user engagement prompt 905 may include other games, user polls, and the like. Accordingly, in some embodiments, the user responses may have a predefined “correct” response. In other embodiments, such as a user poll, no user response 910 may be defined as “incorrect.” In the illustrated embodiment, only the first user engagement prompt 905 is shown but, in other embodiments, the display screen may include more than one user engagements prompts 905. Similarly, additional user responses 910 may be displayed, associated with respective user engagement prompts 905. In the illustrated embodiment, the five user responses 910 are predefined. In other embodiments, one or more of the user responses 910 may be user-defined. For example, an empty text field, a slider, a virtual sketchpad, or any suitable user response field.

In the illustrated embodiment, the response interval counter 915 is a countdown timer displaying the remaining seconds that a user response will be accepted. In other embodiments, one or more response intervals displayed on the response interval counter 915 may be based on a number of participating users, a number of remote locations, a frequency of user response, a ratio of “correct” user responses, and various permutations and combinations thereof. For example, in order to increase rapid user engagement, a response interval may only accept a first quantity of user responses. In the illustrated embodiment, the response interval counter 915 includes an integer display, but the response interval counter may be embodied in any display, such as an hourglass, indicative of a progression. Further, in some embodiments, the response interval counter may be accompanied by one or more notifications, such as an audible alarm or vibration feedback.

In some embodiments, the application may present a sequence of user engagement prompts 905. Accordingly, the response interval counter 915 may display a remaining quantity of “misses” to a user. For example, at a concert, users may be presented with a sequence of user engagement prompts 905 and allotted a limited number of “misses.” Accordingly, the users may participate in an elimination game or match. In some embodiments, the match may continue based on, for example, a quantity or ratio of remaining users.

Alternatively, in the case that an interval has ended or a user has been eliminated from a game, round, or match, the display may present one or more figures related to responses from other users. For example, the display may present a percentage of local users who responded with correct user responses. By way of additional example, in the case that a remote user is participating from a remote location, such as their home, the display may present information related to the responses of other users at the remote location. Accordingly, user engagement during an event may be improved, both at the event location and at one or more remote locations.

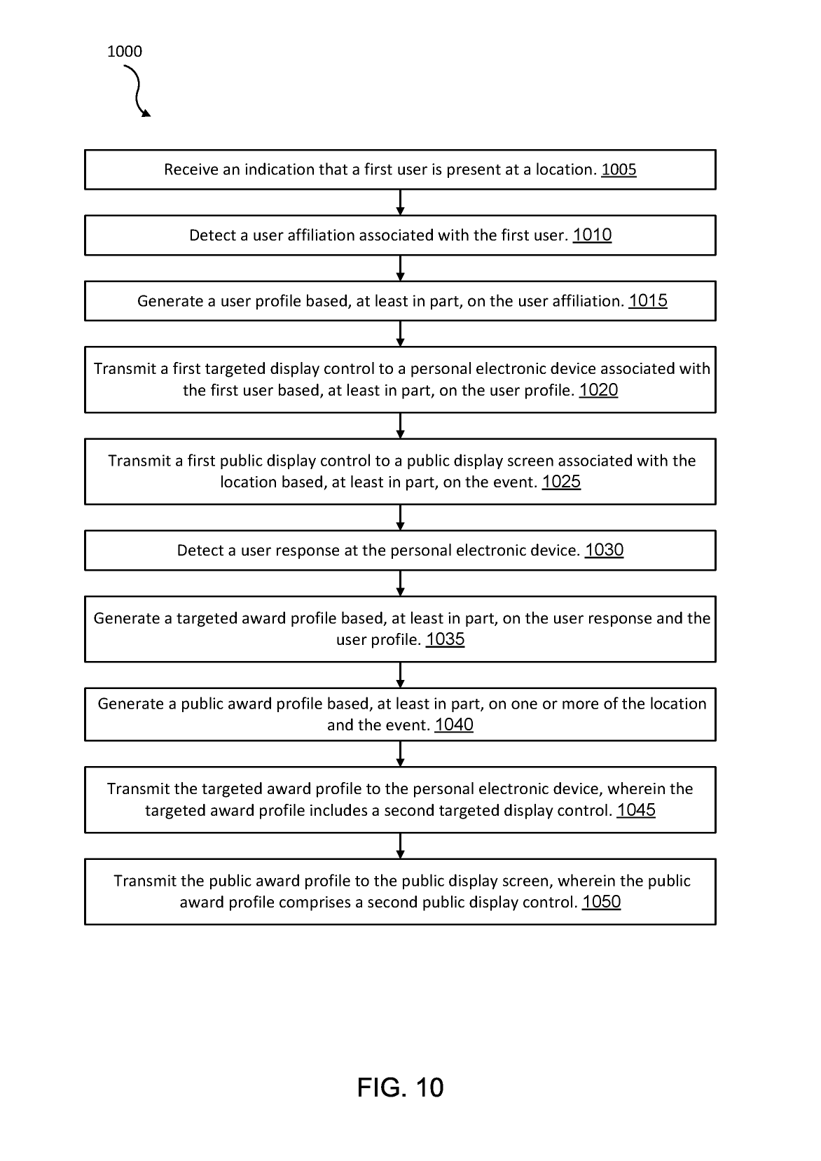

FIG. 10 is a flow diagram of a method 1000 of controlling a plurality of displays at a location during an event. At step 1005, an indication that a first user is present at the location is received. For example, an electronic device associated with the user may transmit the indication to the controller over a network. Alternatively, a sensor associated with the location may detect that the user is present. For example, one or more cameras configured for facial recognition may detect the presence of the first user. At step 1010, a user affiliation associated with the first user is detected. For example, the user may indicate, at the electronic device, the user affiliation. Alternatively, the user affiliation may be detected by, for example, a sensor associated with the location. At step 1015, a user profile is generated based, at least in part, on the user affiliation. For example, the user profile may further include the section, seat, and row of the user. At step 1020, a first targeted display control is transmitted to the electronic device associated with the first user based, at least in part, on the user profile. For example, the targeted display control may include one or more trivia questions. At step 1025, a first public display control is transmitted to a public display associated with the location based, at least in part, on the event. For example, the public display control may be transmitted to a jumbotron or ribbon display at the event location. In some embodiments, the targeted display control and the public display control may be substantially similar, for example, being embodied by the same user engagement prompt or question, or may be adapted based on, for example, one or more user profiles.

At step 1030, a user response is detected at the personal electronic device. For example, the user may select one or more pre-defined user responses associated with one or more questions displayed with the targeted display control or the public display control. At step 1035, a targeted award profile is generated based, at least in part, on the user response and the user profile. For example, the targeted award profile may be generated based, at least in part, on whether the user response is determined to be correct or not. At step 1040, a public award profile is generated based, at least in part, on one or more of the location and the event. At step 1045, the targeted award profile is transmitted to the electronic device. In some embodiments, the targeted award profile includes a second targeted display control. In other embodiments, the targeted award profile may include other data, such as a cryptographic key or identifier. In some embodiments, the second targeted display control includes a matrix barcode, such as a QR code. At step 1050, the public award profile is transmitted to the public display. The public award profile includes a second public display control. For example, the public display control may present one or more limited time offers redeemable during the event. Alternatively, or in addition, the second public display control may include a matrix barcode. Accordingly, users at the location may capture an image of the public award profile for redemption at a later time.

Thus far, an event location has been primarily described as relating a physical location having a physical event. However, in some embodiments, one or more of the location and the event may be virtual. For example, a virtual location may include one or more locations within an interactive digital world, such as a video game or augmented reality platform. Accordingly, a public display may be a virtual display at the virtual location or, in some embodiments, may be a screen on which the virtual location is also displayed. For example, in the context of a sports video game being displayed on a home television, the public display screen may be a virtual ribbon display in the sports arena of the sports video game being displayed. Alternatively, the public display may be a portion of the home television. For example, the public display may be a picture-in-picture display portion of the home television which simultaneously displays the virtual location and virtual event of the sports video game.

Similarly, in some embodiments, the remote location and remote display may be virtual as well. To extend the sports video game example, many video games are configured for network play. Accordingly, a first user and a second user may each have respective instances of the same virtual location and virtual event being displayed on respective home televisions. In some embodiments, a network “host” may be designated as the event location, and a network “guest” may be designated as the remote location. Further, in some embodiments, targeted display controls may be adapted for a virtual location or virtual event. For example, the targeted display controls and user engagement prompts may be configured as a “companion app,” interactive game, or other immersive or engaging display on an electronic device. Similarly, the awards profiles may be adapted for a virtual location or virtual event. For example, the award profiles may redeemable for in-game currency, “loot crates,” or any suitable virtual reward. As some video games require a substantial learning curve, whereas interactive games described herein are readily engaging to most persons, engagement among diverse uses may be improved. For example, continuing with the sports video game example, a teenager may participate in the virtual event at the virtual location, whereas one or both parents may participate in an interactive game via the respective electronic devices. Accordingly, the user engagement prompts and award profiles may be adapted to the virtual event and virtual location, and the parents may be able to earn virtual rewards, increasing overall user engagement.

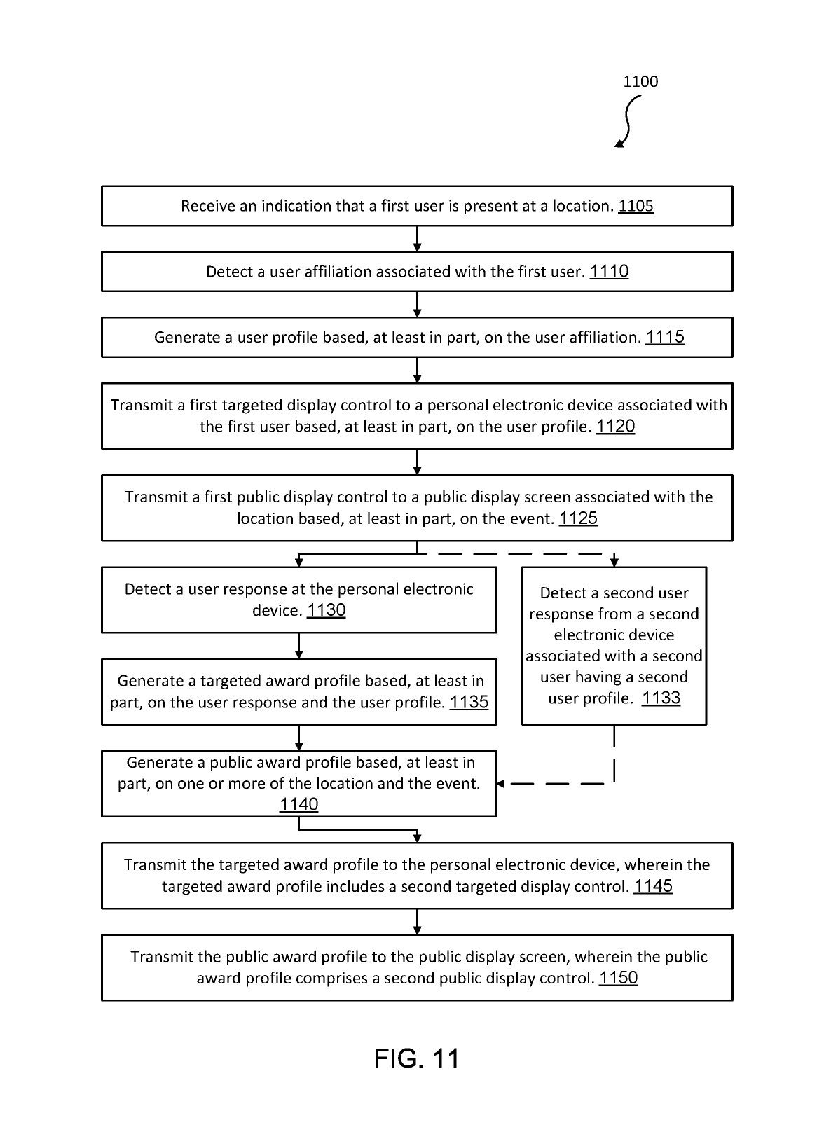

FIG. 11 is a flow diagram of a method 1100 of controlling a plurality of displays during an event, at step 1105, an indication that first user is present at the location is received. For example, an electronic device associated with the user may transmit the indication to the controller over a network. Alternatively, a sensor associated with the location may detect that the user is present. For example, one or more cameras configured for facial recognition may detect a presence of the first user at the location. At step 110, a user affiliation associated with the first user is detected. For example, the user may indicate, at the electronic device the user affiliation. Alternatively, the user affiliation may be detected by, for example, a sensor associated with the location. At step 1115, a user profile is generated based, at least in part, on the user affiliation. For example, the user profile may further include the section, seat, and row of the user. At step 1120, a first targeted display control is transmitted to the electronic device associated with the user based, at least in part, on the user profile. For example, the targeted display control may include one or more trivia questions related to participants in the event. At step 1125, a first public display control is transmitted to a public display associated with the location based, at least in part, on the event. For example, the public display control may be transmitted to a jumbotron or ribbon display at the event location. In some embodiments, the targeted display control and the public display control may be substantially similar, for example, embodied in the same user engagement prompt or questions, or may be adapted based on, for example, one or more user profiles.

At step 1130, a user response is detected at the personal electronic device. For example, the user may select a user-defined response to one or more questions included in the targeted display control or the public display control. In some embodiments, at optional step 1133, a second user response is detected at a second electronic device. In further embodiments, the second electronic device is associated with a second user participating locally or remotely. Accordingly, the second user may be associated with a second user profile. At step 1135, a targeted award profile is generated based, at least in part, on the user response and the user profile. For example, the targeted award profile may be generated based, at least in part, on whether the user responses are determined to be correct or not. At step 1140, a public award profile is generated based, at least in part, on one or more of the location and the event. For example, the public award profile may be generated based, at least in part on a band performing at the event. In some embodiments, the public award profile is generated based, at least in part, on one or more of the second user profile and the second user response. For example, the public award profile may be adapted based on a ratio of correct user responses. Alternatively, or additionally, the public award profile may be adapted based on responses to multiple prompts. At step 1145, the targeted award profile is transmitted to the personal electronic device. In some embodiments, the targeted award profile includes a second targeted display control. In other embodiments, the targeted award profile may include other data, such as a cryptographic key or identifier. In some embodiments, the second targeted display control includes a matrix barcode, such as a QR code. At step 1150, the public award profile is transmitted to the public display. The public award profile includes a second public display control. For example, the second public display control may present one or more limited time offers redeemable during the event. Alternatively, or in addition, the second public display control may include a matrix barcode. Accordingly, users at the location may capture an image of the public award profile for redemption at a later time.

Thus, the disclosure provides, among other things, a system for controlling displays during an event. Various features and advantages of the disclosure are set forth in the following claims.

What is claimed is:

1. A method of controlling a plurality of displays at a location during an event, comprising:
receiving an indication that a first user is present at the location;
detecting a user affiliation associated with the first user;
generating a user profile based, at least in part, on the user affiliation;
transmitting a first targeted display control to a personal electronic device associated with the first user based, at least in part, on the user profile;
transmitting a first public display control to a public display associated with the location based, at least in part, on the event;
detecting a user response at the personal electronic device;
generating a targeted award profile based, at least in part, on the user response and the user profile;
generating a public award profile based, at least in part, on one or more of the location and the event;
transmitting the targeted award profile to the personal electronic device, wherein the targeted award profile comprises a second targeted display control; and
transmitting the public award profile to the public display, wherein the public award profile comprises a second public display control.

2. The method of claim 1, wherein the indication that the first user is present is transmitted from the personal electronic device.

3. The method of claim 1, wherein the user affiliation is detected based on one or more of the indication that the first user is present and detected by a sensor associated with the location.

4. The method of claim 1, wherein one or more of the targeted award profile and the public award profile comprise a matrix barcode.

5. The method of claim 1, further comprising:
transmitting an alert to the personal electronic device approximately concurrently with the transmission of one or more of the display controls.

6. The method of claim 1, further comprising:
adapting the public award profile based, at least in part, on one or more of a second user profile and a second user response detected at a second personal electronic device, wherein the second user profile and the second personal electronic device are associated with a second user at the location.

7. A system for controlling displays at a location during an event, comprising:
an electronic device associated with a first user;
a public display associated with the location;
a controller including a non-transitory computer-readable medium storing program instructions executable by one or more processors to:
receive an indication that the first user is present at the location;
detect a user affiliation associated with the first user;
generate a user profile based, at least in part, on the user affiliation;
transmit a first targeted display control to the electronic device;
transmit a first public display control to the public display based, at least in part, on the event;
detect a user response at the electronic device;
generate a targeted award profile based, at least in part, on one or more of the user profile and the user response;
generate a public award profile based, at least in part, on one or more of the event and the user response;
transmit the targeted award profile to the electronic device, wherein the targeted award profile comprises a second targeted display control;
transmit the public award profile to the public display, wherein the public award profile comprises a second public display control.

8. The system of claim 7, wherein the indication that the first user is present is transmitted from the electronic device.

9. The system of claim 7, further comprising:
a sensor associated with the location, wherein the user affiliation is detected based on one or more of the indication that the first user is present and detected by the sensor.

10. The system of claim 7, wherein one or more of targeted award profile and the public award profile comprise a matrix barcode.

11. The system of claim 7, wherein the program instructions are further executable to:
transmit an alert to the electronic device approximately concurrently with the transmission of one or more of the display controls.

12. The system of claim 7, wherein the program instructions are further executable to:
adapt the public award profile based, at least in part, on one or more of a second user profile and a second user response detected at a second personal electronic device, wherein the second user profile and the second personal electronic device are associated with a second user at the location.

13. The system of claim 7, further comprising:
a second public display associated with the location, wherein the program instructions are further executable to:
generate a continuous award profile; and
transmit the continuous award profile to the second public display, wherein the continuous award profile comprises a third public display control.

14. A system for controlling displays during an event, comprising:
an event display associated with an event location;
a remote display associated with a remote location apart from the event location;
a controller including a non-transitory computer-readable medium storing program instructions executable by one or more processors to:
receive an indication that at least one local user is present at the event location;
receive an indication that at least one remote user is present at the remote location;
detect respective user affiliations associated with the at least one local user and the at least one remote user;
generate respective user profiles based, at least in part, on the user affiliations;
transmit a first public display control to the event display and the remote display;
transmit a first targeted display control to at least one electronic device associated with the at least one local user and to at least one electronic device associated with the at least one remote user based, at least in part, on the respective user affiliation and user location;
detect respective user responses associated with the at least one local user and the at least one remote user;
generate a public award profile based, at least in part, on the event;
generate a victory award profile based, at least in part, on the user responses;
generate a participation award profile based, at least in part, on the user responses;
transmit the public award profile to the event display and the remote display, wherein the public award profile comprises a second public display control;
transmit the victory award profile to electronic devices associate with a plurality of users selected from the at least one local user and the at least one remote user, wherein the victory award profile comprises a second targeted display control;
transmit the participation award profile to electronic devices associated with a plurality of users selected from the at least one local user and the at least one remote user, wherein the participation award profile comprises a third targeted display control.

15. The system of claim 14, wherein at least one of the indication that the at least one local user is present and the indication that the at least one remote user is present is transmitted from the at least one electronic device associated with the at least one local user and the at least one electronic device associated with the at least one remote user.

16. The system of claim 14, further comprising:
a sensor associated with the event location, wherein the at least one user affiliation is detected based on one or more of the indication that the at least one local user is present and detected by the sensor.

17. The system of claim 14, wherein at least one award profile comprises a matrix barcode.

18. The system of claim 14, wherein the program instructions are further executable to:
transmit an alert to at least one of the at least one electronic device associated with the at least one local user and the at least one electronic device associated with the at least one remote user approximately concurrently with the transmission of at least one display control.

19. The system of claim 14, wherein the program instructions are further executable to:
transmit a remote public display control to the remote display;
transmit a remote targeted display control to the at least one electronic device associated with the at least one remote user;
generate a remote public award profile based, at least in part, on the event and the remote location;
generate a remote victory award profile based, at least in part, on the user responses associated with the at least one remote user;
generate a remote participation award profile based, at least in part, on the user responses associated with the at least one remote user;
transmit the remote public award profile to the remote display, wherein the remote public award profile comprises a second remote public display control;
transmit the remote victory award profile to at least one electronic device associated with a plurality of users selected from the at least one remote user, wherein the remote victory award profile comprises a second remote targeted display control; and
transmit the remote participation award profile to at least one electronic device associated with a plurality of users selected from the at least one remote user, wherein the remote participation award profile comprises a third remote targeted display control.

20. The system of claim 19, wherein the program instructions are further executable to:
one or more adapt at least one award profile based, at least in part, on the user profiles and the user responses.
